(19) United States
(12) Patent Application Publication
(10) Pub. No.: US 2014/0244529 A1
(43) Pub. Date: Aug. 28, 2014

(54) Banknote Processing Apparatus for Detecting, Reporting, and Integrally Managing Counterfeit Banknotes and Method of Controlling the Same

(71) Applicant: Sang Hwan JANG, Seoul (KR)

(72) Inventor: Sang Hwan JANG, Seoul (KR)

(73) Assignee: KISAN ELECTRONICS CO., LTD., Seoul (KR)

(21) Appl. No.: 14/018,421

(22) Filed: Sep. 5, 2013

(30) Foreign Application Priority Data
Feb. 28, 2013 (KR) 10-2013-0022528

(51) Int. Cl. G06Q 30/00

(52) U.S. Cl. CPC G06Q 30/0185
USPC 705/318

(57) ABSTRACT

A method of controlling a banknote processing apparatus for detecting, reporting, and integrally managing counterfeit banknotes includes detecting an injected banknote through an injection detecting unit; determining whether the injected banknote is a counterfeit banknote; obtaining counterfeit banknote information including a serial number of a banknote firmly determined as a counterfeit banknote; and transmitting the counterfeit banknote information including the serial number to a counterfeit banknote management system of a central bank through a communication unit when a counterfeit banknote report command previously set by a user is input. Since the blacklist of counterfeit banknotes established by the counterfeit banknote management system of the central bank is received and it is determined whether the injected banknote is a counterfeit banknote based on the received blacklist, accuracy of discriminating counterfeit banknotes of financial facilities including banks is improved.

### CROSS-REFERENCE TO RELATED APPLICATION

The present application claims the benefit of a priority of Korean Patent Application No. 10-2013-0022528 filed with the Korean Intellectual Property Office on Feb. 28, 2013.

### BACKGROUND OF THE INVENTION

1. Field of the Invention

The present invention relates to a banknote processing apparatus for detecting, reporting, and integrally managing counterfeit banknotes and a method of controlling the same, and more particularly, to a banknote processing apparatus for detecting, reporting, and integrally managing counterfeit banknotes to integrally manage a blacklist of counterfeit banknotes established by a central bank and information on counterfeit banknotes discriminated by banknote processing apparatuses installed in financial facilities including banks in association with counterfeit banknote information of the financial facilities including banks and the central bank and a method of controlling the same.

2. Description of the Related Art

With development of an electrical and electronic technology and a digital technology, a banknote forging method is continuously developed so that counterfeit banknotes so elaborate that may not be distinguished from genuine banknotes with the naked eye are fabricated and the number of detected counterfeit banknotes is increasing every year.

A central bank publicizes illegality of forgery of banknotes and counterfeit banknote discriminating methods through various media such as Internet banner advertisements in order to prevent forgery of banknotes. Furthermore, in order to detect counterfeit banknotes early, the central bank establishes a counterfeit banknote management system including a database for sharing information such as characteristics and serial numbers of detected counterfeit banknotes and methods of counterfeiters with the National Police, financial facilities including banks, and related administrative agencies.

In order to efficiently operate such a counterfeit banknote management system, the financial facilities including banks need to provide information on counterfeit banknotes whenever are detected by each of them to the central bank and help renew the database.

Each branch of the financial facilities including banks has banknote counters for automatically counting banknotes. The banknote counters not only count the banknotes but also discriminate fit banknotes, unfit banknotes, counterfeit banknotes, and soiled banknotes.

In a conventional art, when the counterfeit banknotes are detected by the banknote counters, in order for staffs of the financial facilities including banks to provide the information on the separately detected counterfeit banknotes to the central bank, the information on the counterfeit banknotes must be transmitted in the form of data processing files in due form or must be directly input on a web screen. Therefore, the number of counterfeit banknotes which are reported to the central bank is much smaller than the actual number of the detected counterfeit banknotes so that a comprehensive management policy of the counterfeit banknotes is insufficient.

Korean Patent Application Publication No. 10-2009-0124457 (published on Dec. 3, 2009) is a prior art of the present invention.

### SUMMARY OF THE INVENTION

Accordingly, the present invention has been made in an effort to solve the above problems. It is an object of the present invention to provide a banknote processing apparatus for detecting, reporting, and integrally managing counterfeit banknotes capable of receiving a blacklist of counterfeit banknotes established by a central bank in association with information of financial facilities including banks and the central bank, banknote processing apparatuses of the financial facilities including banks detecting counterfeit banknotes based on the blacklist, or executing a simple counterfeit banknote reporting function simply by a user when the counterfeit banknotes detected by the banknote processing apparatuses are finally determined as counterfeit banknotes to easily provide information on the counterfeit banknotes to the central bank and a method of controlling the same.

According to one aspect of the present invention, a method of controlling a banknote processing apparatus for detecting, reporting, and integrally managing counterfeit banknotes includes detecting an injected banknote through an injection detecting unit; determining whether the injected banknote is a counterfeit banknote; obtaining counterfeit banknote information including a serial number of a banknote firmly determined as a counterfeit banknote; and transmitting the counterfeit banknote information including the serial number to a counterfeit banknote management system of a central bank through a communication unit when a counterfeit banknote report command previously set by a user is input.

According to another aspect of the present invention, a banknote processing apparatus for detecting, reporting, and integrally managing counterfeit banknotes includes an injection detecting unit for detecting a banknote injected into the banknote processing apparatus; an image obtaining unit for obtaining an image of the injected banknote; a sensor unit for sensing security components of the injected banknote; a communication unit for communicating with a counterfeit banknote management system of a central bank; and a controller for comparing the image and a sensing signal of the banknote with those of a genuine banknote to determine whether the banknote is a counterfeit banknote, wherein the controller transmits counterfeit banknote information including a serial number of the banknote determined as a counterfeit banknote to the counterfeit banknote management system through the communication unit when a counterfeit banknote report command previously set by a user is input.

According to the present invention, since the blacklist of counterfeit banknotes established by the counterfeit banknote management system of the central bank is received and it is determined whether the injected banknote is a counterfeit banknote based on the received blacklist, it is possible to improve accuracy of discriminating counterfeit banknotes of financial facilities including banks.

In addition, according to the present invention, since information on counterfeit banknotes firmly discriminated as a counterfeit by the financial facilities including banks is reported to the central bank and concentrated on the central bank by a user simply manipulating a counterfeit banknote report button of the banknote processing apparatus, the central bank can integrally manage the number of counterfeit banknotes and forging methods.

### BRIEF DESCRIPTION OF THE DRAWINGS

FIG. 1 is a block diagram of a banknote processing apparatus for detecting, reporting, and integrally managing counterfeit banknotes according to an embodiment of the present invention; and

FIG. 2 is a flowchart illustrating processes of a method of controlling a banknote processing apparatus for detecting, reporting, and integrally managing counterfeit banknotes according to an embodiment of the present invention.

### DETAILED DESCRIPTION OF THE INVENTION

Hereinafter, a banknote processing apparatus for detecting, reporting, and integrally managing counterfeit banknotes according to an embodiment of the present invention and a method of controlling the same will be described in detail with reference to the attached drawings. In the drawings, thicknesses of lines or sizes of elements may be exaggerated for clarity. In addition, the following terms defined in consideration of functions in the present invention may vary with intensions of a user and an operator or custom. Therefore, definitions of such terms must be performed based on an entire content of the present specification.

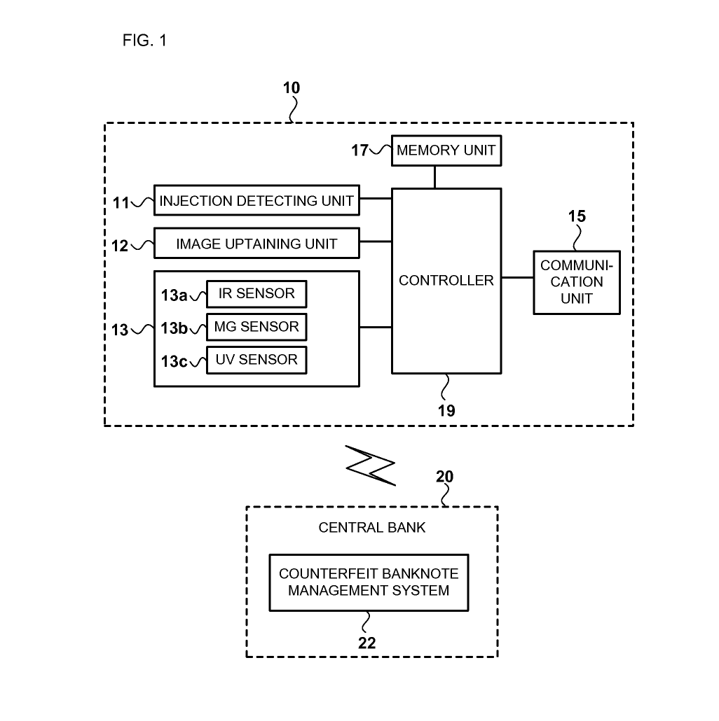

Referring to FIG. 1, a banknote processing apparatus 10 for detecting, reporting, and integrally managing counterfeit banknotes includes an injection detecting unit 11, an image obtaining unit 12, a sensor unit 13, a communication unit 15, a memory unit 17, and a controller 19.

The injection detecting unit 11 detects a banknote injected into the banknote processing apparatus 10 to generate a sensing signal and transmit the generated sensing signal to the controller 19 and may detect injection of the banknote through various sensors such as a contact sensor.

The image obtaining unit 12 obtains an image of the banknote injected into the banknote processing apparatus 10 such as various designs or patterns, a concealed picture, a security thread, a denomination, and a serial number printed to the banknote to transmit the obtained images to the controller 19.

The sensor unit 13 senses specific security components included in the banknote to transmit the sensing signal to the controller 19. In particular, the sensor unit 13 according to an embodiment of the present invention includes an infrared (IR) sensor 13a, a magnetic (MG) sensor 13b, and an ultraviolet (UV) sensor 13c.

The IR sensor 13a irradiates IR rays on the banknote when the injected banknote passes through the sensor unit and transmits an IR sensing signal of the banknote formed by an IR component reflected from the banknote or an IR component passed through the banknote to the controller 19.

The MG sensor 13b senses a magnetic component included in the banknote to transmit a magnetic sensing signal of the banknote to the controller 19. The UV sensor 13c irradiates UV rays on the injected banknote and transmits an UV sensing signal of the banknote formed by an UV or fluorescent component reflected from the banknote or an UV or fluorescent component passed through the banknote to the controller 19.

The communication unit 15 communicates with a counterfeit management system 22 of a central bank 20 and receives a blacklist of counterfeit banknotes to transmit the received blacklist to the controller 19 or transmits information on a banknote determined as a counterfeit banknote by the banknote processing apparatus 10, a bank staff using the apparatus 10, etc. to a counterfeit banknote management system 22.

At this time, the blacklist means a list of serial numbers of counterfeit banknotes reported to and established by the central bank 20. The blacklist is not limited to the above but may include various information items such as a forged section and a forging method of the counterfeit banknotes, which are features of determining as a counterfeit banknote.

The controller 19 identifies a serial number of the injected banknote through the image obtaining unit 12 and determines whether the identified serial number exists in the blacklist received by the communication unit 15 to determine whether the banknote is a counterfeit banknote. That is, since counterfeit banknotes often have the same serial number, when a serial number of a counterfeit banknote included in the blacklist is the same as the serial number of the injected banknote, the controller 19 determines the injected banknote as a counterfeit banknote.

In addition, the controller 19 may determine whether a banknote is a counterfeit banknote based on various information items such as the concealed picture and the security thread of the banknote obtained by the image obtaining unit 12. The controller 19 compares the sensing signal of the banknote sensed by the sensor unit 13 with a previously stored sensing signal of a genuine banknote to determine whether the injected banknote is a counterfeit banknote.

When the injected banknote is determined as a counterfeit banknote based on the information obtained by the image obtaining unit 12 and the sensor unit 13, the controller 19 transmits counterfeit banknote information including the serial number of the injected banknote to the counterfeit banknote management system 22 of the central bank 20 through the communication unit 15 to report that a counterfeit banknote is detected. At this time, detection of the counterfeit banknote is reported such that the counterfeit banknote information is transmitted to the counterfeit banknote management system 22 through the communication unit 15 when a user performs a simple input manipulation, that is, presses or touches a manipulation button (not shown) that inputs a counterfeit banknote report command.

At this time, the counterfeit banknote information may include at least one of a denomination of a banknote, the number of sheets, an image of a banknote, a counterfeit banknote detection time, a detector (a user ID), a machine's own ID number, a detection place (a branch code), a detection circumstance (during sorting fitness, during exchange, during deposit at a teller desk, or during deposit into an ATM), sensing signals of the sensor unit, quality of a banknote material, and a counterfeit type as well as the serial number of the banknote. The counterfeit banknote information may further include other various information items.

Therefore, the central bank 20 that receives the counterfeit banknote information from the controller 19 can update the blacklist of the counterfeit banknote management system 22 to integrally manage the counterfeit banknote information in real time.

According to the present embodiment, the banknote processing apparatus 10 may further include a memory unit 17 configured to store the blacklist received by the communication unit 15 and the counterfeit banknote information including the serial number of the banknote determined as a counterfeit banknote by the apparatus 10 so that the banknote processing apparatus 10 in itself may integrally manage a counterfeit banknote.

In particular, according to the present embodiment, periodically or when a banknote is injected into the banknote processing apparatus 10, the controller 19 receives the blacklist of the counterfeit banknote management system 22 through the communication unit 15 to update the blacklist stored in the memory unit 17.

Operation processes of the banknote processing apparatus 10 for detecting, reporting, and integrally managing a counterfeit banknote will be below described in detail.

Thus, the counterfeit banknote information detected by the banknote processing apparatus 10 installed in each of the financial facilities including banks in the above-described method may be integrally managed by the central bank 20 in real time. Since the banknote processing apparatus 10 of each of the financial facilities including banks receives the blacklist from the counterfeit management system 22 of the central bank 20 to process the injected banknote, the banknote processing apparatus 10 may correctly determine whether the injected banknote is a counterfeit banknote. Only when the injected banknote is determined as a counterfeit banknote, since it is reported by a simple manipulation of the user to the counterfeit banknote management system 22 that a counterfeit banknote is detected, it is possible to prevent a genuine banknote from being determined as a counterfeit banknote to be automatically reported due to a recognition error of the banknote processing apparatus.

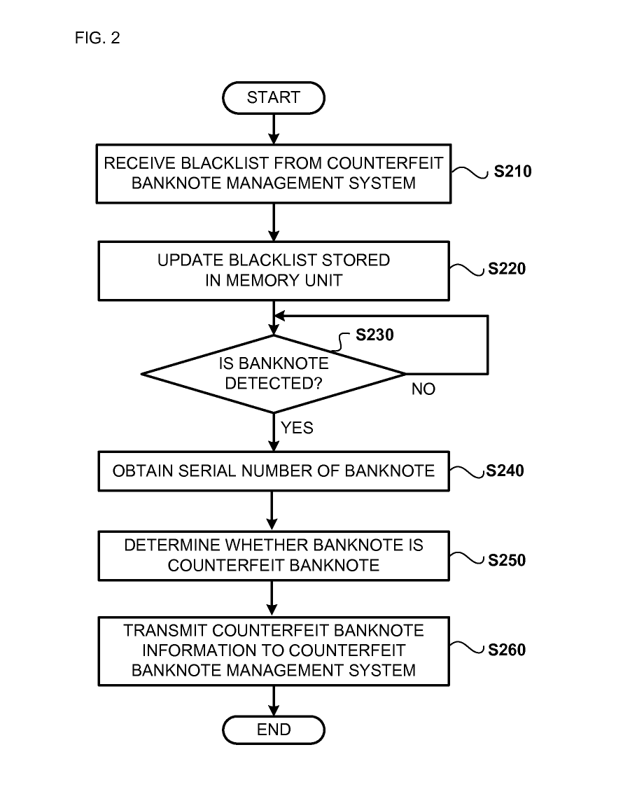

Referring to FIG. 2, processes of realizing a method of controlling a banknote processing apparatus for detecting, reporting, and integrally managing counterfeit banknotes according to an embodiment of the present invention will be described. Description of the same terms and technical contents will be omitted.

First, the controller 19 periodically receives the blacklist from the counterfeit banknote management system 22 of the central bank 20 through the communication unit 15 S210.

Then, the controller 19 updates the blacklist previously stored in the memory unit 17 based on the blacklist received from the counterfeit banknote management system 22 S220.

According to the present embodiment, it is described that the blacklist is periodically received. However, the present invention is not limited to the above but the blacklist may be received when a banknote is injected or when the banknote processing apparatus is initially operated.

In addition, in the above-described processes S210 and S220, a version of the blacklist of the counterfeit banknote management system 22 may be received and the received version may be compared with a version of the blacklist previously stored in the memory unit 17 so that the blacklist previously stored in the memory unit 17 may be updated when a blacklist of a new version is received.

Then, the controller 19 detects a banknote injected through the injection detecting unit 11 S230. When the injected banknote is detected, the controller 19 obtains a serial number of the injected banknote through the image obtaining unit 12 S240. In addition it may obtain a banknote image such as various designs or patterns, a concealed picture, a security thread, and a denomination printed onto the banknote through the image obtaining unit 12.

Then, the controller 19 determines whether the injected banknote is a counterfeit banknote S250. To be specific, the controller 19 may firstly determine whether the serial number obtained by the image obtaining unit 12 exists in the blacklist received by the communication unit 15, secondly compare the image of the banknote obtained by the image obtaining unit 12 with an image of a genuine banknote to determine whether the injected banknote is a counterfeit banknote, and thirdly compare a sensing signal of the banknote sensed by the sensor unit 13 with a previously stored sensing signal of the genuine banknote to determine whether the banknote is a counterfeit banknote. The above processes may be performed in a reverse order or in an arbitrary order. In addition, only one of the above processes may be performed in accordance with an environment or selection of anyone skilled in the art.

In particular, when it is determined whether the injected banknote is a counterfeit banknote by the sensor unit 13, according to the present embodiment, at least one of an IR signal of the banknote sensed by the IR sensor 13a, a MG signal of the banknote sensed by the MG sensor 13b, and an UV signal of the banknote sensed by the UV sensor 13c is compared with a corresponding signal of the genuine banknote to determine whether the injected banknote is a counterfeit banknote so that it is possible to improve accuracy of discriminating counterfeit banknotes.

In addition, the method of determining whether the injected banknote is a counterfeit banknote is not limited to the above but various counterfeit banknote discriminating methods that are published or that are not published may be used.

When it is determined that the injected banknote is a counterfeit banknote in S250, the controller 19 transmits counterfeit banknote information including the serial number to the counterfeit banknote management system 22 to report that a counterfeit banknote is detected S260.

Detection of the counterfeit banknote is reported such that the counterfeit banknote information is transmitted to the counterfeit banknote management system 22 through the communication unit 15 when the user performs the simple input manipulation, that is, presses or touches the manipulation button (not shown) that inputs the counterfeit banknote report command. At this time, for example, in order to prevent a genuine banknote from being determined as a counterfeit banknote to be automatically reported due to a recognition error of the banknote processing apparatus and thus, to prevent circulation of the corresponding genuine banknote from being prohibited and wrong counterfeit banknote information from being updated in the blacklist, banknotes determined as counterfeit banknotes by the banknote processing apparatus may be finally determined as counterfeit banknotes by a high precision banknote processing apparatus or further discrimination of a bank staff to be reported to the counterfeit banknote management system 22.

That is, when a counterfeit banknote is detected while banknotes are injected into the banknote processing apparatus 10 to be counted, the controller 19 outputs an alarm through an output unit (not shown) of the banknote processing apparatus 10. When the user presses a pre-set manipulation button (or touches a corresponding icon in a touch type) after checking the alarm and determining whether the detected banknote is a counterfeit banknote, the counterfeit banknote information may be transmitted. In this case, the counterfeit banknote information may be transmitted by using an existing button or an additional button added to the banknote processing apparatus 10 or.

As described above, according to the present embodiment, since the user further determines whether the banknote determined as a counterfeit banknote by the banknote processing apparatus 10 is a counterfeit banknote and transmits the counterfeit banknote information, correct counterfeit banknote information may be integrally managed.

The present embodiment is not limited to the above but the counterfeit banknote information may be transmitted in various methods such as a method in which the counterfeit banknote information is automatically transmitted when a banknote determined as a counterfeit banknote is detected.

According to the present embodiment, since the blacklist of counterfeit banknotes established by the counterfeit banknote management system 22 of the central bank 20 is received and it is determined whether a banknote is a counterfeit banknote based on the received blacklist, it is possible to improve accuracy of discriminating counterfeit banknotes in the financial facilities including banks.

According to the present embodiment, since information on counterfeit banknotes discriminated by the financial facilities including banks is concentrated on the central bank 20 by the user simply manipulating a counterfeit banknote report button of the banknote processing apparatus 10, the central bank 20 may integrally manage the number of counterfeit banknotes and forging methods, etc.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling a banknote processing apparatus for detecting, reporting, and integrally managing counterfeit banknotes, the method comprising the steps of:
detecting an injected banknote through an injection detecting unit;
determining whether the injected banknote is a counterfeit banknote;
obtaining counterfeit banknote information including a serial number of a banknote firmly determined as a counterfeit banknote; and
transmitting the counterfeit banknote information including the serial number to a counterfeit banknote management system of a central bank through a communication unit when a counterfeit banknote report command previously set by a user is input.

2. The method of claim 1, wherein, in the step of determining whether the injected banknote is a counterfeit banknote, it is determined whether the injected banknote is a counterfeit banknote based on at least one of an infrared (IR) signal of the banknote sensed by an IR sensor, a magnetic (MG) signal of the banknote sensed by an MG sensor, and an ultraviolet (UV) signal of the banknote sensed by an UV sensor.

3. The method of claim 1, further comprising receiving a blacklist from the counterfeit banknote management system of the central bank through the communication unit,
wherein it is determined whether a serial number of the injected banknote exists in the blacklist to determine whether the injected banknote is a counterfeit banknote.

4. The method of claim 1, wherein the step of determining whether the injected banknote is a counterfeit banknote comprises finally determining whether a banknote determined as a counterfeit banknote by the banknote processing apparatus is a counterfeit banknote.

5. The method of claim 1, wherein the counterfeit banknote information further comprises at least one of a denomination of a banknote, the number of sheets, an image of a banknote, a counterfeit banknote detection time, a detector (a user ID), a machine's own ID number, a detection place (a branch code), a detection circumstance (during sorting fitness, during exchange, during deposit at a teller desk, or during deposit into an ATM), a sensing signal of a sensor unit, quality of a banknote material, and a counterfeit type.

6. The method of claim 3, wherein the blacklist includes a list of the serial numbers of the counterfeit banknotes or a forged section and a forging method of the counterfeit banknotes.

7. The method of claim 1, wherein the step of determining whether the injected banknote is a counterfeit banknote may include comparing a sensing signal of the banknote sensed by a sensor unit with a previously stored sensing signal of a genuine banknote to determine whether the injected banknote is a counterfeit banknote.

8. The method of claim 3, further comprising storing the blacklist received by the communication unit and the counterfeit banknote information.

9. The method of claim 3, further comprising updating the blacklist periodically, when the injection of the banknote is detected, or when the banknote processing apparatus is initially operated.

10. The method of claim 9, wherein the step of updating the blacklist comprises comparing a version of the blacklist from the counterfeit banknote management system with a version of the blacklist previously received so that the blacklist previously received may be updated when a blacklist of a new version is received.

11. A banknote processing apparatus for detecting, reporting, and integrally managing counterfeit banknotes, comprising:
an injection detecting unit for detecting a banknote injected into the banknote processing apparatus;
an image obtaining unit for obtaining an image of the injected banknote;
a sensor unit for sensing security components of the injected banknote;
a communication unit for communicating with a counterfeit banknote management system of a central bank; and
a controller for comparing the image and a sensing signal of the banknote with those of a genuine banknote to determine whether the banknote is a counterfeit banknote,
wherein the controller transmits counterfeit banknote information including a serial number of the banknote determined as a counterfeit banknote to the counterfeit banknote management system through the communication unit when a counterfeit banknote report command previously set by a user is input.

12. The banknote processing apparatus of claim 11, wherein the sensor unit comprises:
an IR sensor for sensing an IR signal of the banknote;
an MG sensor for sensing an MG signal of the banknote; and
an UV sensor for sensing an UV signal of the banknote, and
wherein the controller determines whether the injected banknote is a counterfeit banknote based on at least one of the IR signal of the banknote sensed by the IR sensor, the MG signal of the banknote sensed by the MG sensor, and the UV signal of the banknote sensed by the UV sensor.

13. The banknote processing apparatus of claim 11, wherein the controller receives a blacklist from the counterfeit banknote management system of the central bank through the communication unit and determines whether the serial number of the injected banknote exists in the blacklist to determine whether the injected banknote is a counterfeit banknote.

14. The banknote processing apparatus of claim 11, wherein the counterfeit banknote information further comprises at least one of a denomination of a banknote, the number of sheets, an image of a banknote, a counterfeit banknote detection time, a detector (a user ID), a machine's own ID number, a detection place (a branch code), a detection circumstance (during sorting fitness, during exchange, during deposit at a teller desk, or during deposit into an ATM), a sensing signal of a sensor unit, quality of a banknote material, and a counterfeit type.

15. The banknote processing apparatus of claim 13, wherein the blacklist includes a list of the serial numbers of the counterfeit banknotes or a forged section and a forging method of the counterfeit banknotes.

16. The banknote processing apparatus of claim 11, wherein the image obtaining unit obtains at least one of a design, a pattern, a concealed picture, a security thread, a denomination, and a serial number printed to the banknote injected into the banknote processing apparatus to transmit the obtained images to the controller.

17. The banknote processing apparatus of claim 13, wherein the central bank that receives the counterfeit banknote information from the controller can update the blacklist of the counterfeit banknote management system.

18. The banknote processing apparatus of claim 13, further comprises a memory unit configured to store the blacklist receiving from the counterfeit banknote management system and the counterfeit banknote information.

19. The banknote processing apparatus of claim 13, wherein the controller receives the blacklist of the counterfeit banknote management system to update the blacklist stored in the memory unit periodically, when a banknote is injected into the apparatus, or when the apparatus is initially operated.

20. The banknote processing apparatus of claim 13, wherein the controller compares a version of the blacklist from the counterfeit banknote management with a version of the blacklist previously received so that the blacklist previously received may be updated when a blacklist of a new version is received.
